(19) United States
(12) Patent Application Publication
(10) Pub. No.: US 2006/0204702 A1
(43) Pub. Date: Sep. 14, 2006

(54) Article for securing to the skin, the nails, hair or false nails

(75) Inventor: Ludovic Thevenet, Bourg La Reine (FR)

Correspondence Address: OLIFF & BERRIDGE, PLC, P.O. BOX 19928, ALEXANDRIA, VA, 22320, US

(73) Assignee: L'OREAL, PARIS (FR)

(21) Appl. No.: 11/369,996

(22) Filed: Mar. 8, 2006

Related U.S. Application Data
(60) Provisional application No. 60/667,100, filed on Apr. 1, 2005.

(30) Foreign Application Priority Data
Mar. 9, 2005 (FR) 05 50622

(51) Int. Cl. B32B 33/00

(52) U.S. Cl. 428/40.1

(57) ABSTRACT

An article may be configured to be secured to keratinous materials, in particular skin or nails. The article may contain magnetic particles that are oriented in at least one pattern.

### CROSS-REFERENCE TO RELATED APPLICATION

This non-provisional application claims the benefit of French Application No. 05 50622 filed on Mar. 9, 2005 and U.S. Provisional Application No. 60/667,100 filed on Apr. 1, 2005, the entire disclosures of which are incorporated herein by reference.

The present invention relates to an article for securing to skin, hair, nails, or false nails, and to a method of manufacturing such an article.

### SUMMARY

A need exists to benefit from novel optical effects in the field of makeup. Exemplary embodiments of the present invention seek to satisfy that need.

Exemplary embodiments of the present invention may provide an article configured to be secured to skin, hair, nails, or false nails, the article containing magnetic particles that are oriented in at least one pattern.

For example, the article may comprise a patch or a false nail that covers all or part of a natural nail, or may comprise any other ornamental device configured to be secured to keratinous materials.

In exemplary embodiments, the magnetic particles may be spread over all or part of the article.

In exemplary embodiments, the appearance of the article may depend on an orientation and/or a location of the magnetic particles. Exemplary embodiments may make it possible to create novel makeup effects, for example, for skin, hair, nails, or false nails, by using the article. The article may include one or more patterns, for example, geometrical or otherwise, in relief or imparting an impression of relief.

In exemplary embodiments, the article may have a decorative use and/or may be used to conceal an imperfection in skin or nails, for example.

In exemplary embodiments, the magnetic particles may include an orientation that is set within the article, for example, at the moment of use, i.e., once the particles have set, such that exposing the particles to a magnetic field no longer has the effect of modifying their orientation in a visibly perceptible manner.

In exemplary embodiments, the article may comprise at least a first layer comprising a material containing the magnetic particles. For example, the first layer may comprise a polymer film, obtained by drying a film-forming material containing at least one solvent.

To secure the article to skin, hair, nails, or false nails, the article may include an adhesive face, which, before use, may be covered by a removable protective membrane.

In exemplary embodiments, the adhesive face may be defined by at least a second layer comprising at least one adhesive material. For example, the adhesive material may be selected such that the article is repositionable.

In exemplary embodiments, the article may also include an adhesive capability without using a specific adhesive, for example, because of adhesive properties of the first layer.

In exemplary embodiments, the article may be supplied to the user without an adhesive face, and may be secured to skin by an adhesive, for example, a glue or an adhesive film that is compatible with such a use, that is deposited on the article and/or on skin, hair, nails or false nails, before the article is applied.

In exemplary embodiments, the article may cover all or part of a natural nail or a false nail. The article may include a protective film that is arranged to protect the first layer.

In exemplary embodiments, the protective film may be adhesive. In exemplary embodiments in which the first layer does not cover the entire adhesive face of the protective film, the protective film may hold the article in place on the nail.

For example, the pattern formed by the first layer may be surrounded completely by the adhesive face of the protective film, so as to enable the protective film to adhere to the nail around the entire pattern.

In exemplary embodiments, the article may be flexible or may be substantially rigid. The article may include a flexibility that is sufficient to enable the article to be stretched, thereby enabling the article to be fitted to a surface of a nail, for example.

In exemplary embodiments, the article may be sensitive to organic solvents, thereby enabling the article to be removed, for example, by a nail-vanish remover, as opposed to a false nail that needs to be taken off. Thus, the article may be removed by solvents, in particular, organic solvents.

In exemplary embodiments, the article may advantageously last for a significant period of time, for example, a period of at least several days, or even at least a week.

U.S. Pat. Nos. 5,415,903, 5,525,389, and 4,903,840, the entire discloses of which are incorporated herein by reference, describe examples of methods of manufacturing adhesive articles. Such methods include at least some steps that may be used to manufacture articles in accordance with exemplary embodiments of the invention.

For a multi-layer structure, various layers may include compositions and/or thicknesses that are identical or that are different.

In exemplary embodiments, the magnetic particles of the article may comprise a magnetic material selected from the group consisting of: iron, nickel, cobalt, and alloys and oxides thereof, for example, Fe₃O₄. In the absence of a magnetic field, the magnetic particles used may preferably not include any remnant magnetism.

In exemplary embodiments, the magnetic particles may comprise any magnetic material that includes sensitivity to lines of a magnetic field, regardless of whether the field is produced by a permanent magnet or is the result of induction. For example, the material may be selected from nickel, cobalt, iron, and alloys and oxides thereof, for example, Fe₃O₄. The material may also be selected from gadolinium, terbium, dysprosium, erbium, and alloys and oxides thereof, for example. The magnetic material may be of the “soft” or of the “hard” type.

In exemplary embodiments, the magnetic particles may include a multi-layer structure including at least one layer of a magnetic material such as iron, nickel, cobalt, and alloys and oxides thereof, for example, Fe₃O₄.

In exemplary embodiments, the magnetic particles may include an anisotropic character. The magnetic particles may preferably be aspherical, including an elongate shape, for example. Thus, when the particles are subjected to a magnetic field, for example, during manufacture of the article, the particles may tend to become oriented with their longitudinal axes in alignment with field lines of the magnetic filed, and may be subjected to a change in orientation that results in a change in appearance resulting from the anisotropy and creating the pattern(s).

In exemplary embodiments in which the magnetic particles are substantially spherical, the appearance thereof may preferably be non-uniform, so that a change in orientation results in a change in appearance. A quantity of magnetic particles in the article may be sufficient to enable the appearance of the article to depend on the orientation and/or the positioning of the particles.

For example, a size of the magnetic particles may be in a range of about 1 nanometer (nm) to about 700 micrometers (μm), in a range of about 1 μm to about 500 μm, or in a range of about 10 μm to about 150 μm. The term “size” means a dimension given by a statistical grain size distribution at half the population, referred to as “D50”.

In exemplary embodiments, the magnetic particles of the article may comprise magnetic pigments. Particularly suitable pigments may include nacres comprising iron oxide Fe₃O₄. For example, pigments including magnetic properties may include those sold under the trade names Colorona Blackstar Blue, Colorona Blackstar Green, Colorona Blackstar Gold, Colorona Blackstar Red, Microna Matte Black (17437), Mica Black (17260), Colorona Patina Silver (17289), Colorona Patina Gold (17288) by MERCK, Gemtone Moonstone (G 004), or Chroma-Lite Black (4498) by ENGELHARD.

In addition to the magnetic particles, the article may contain at least one coloring substance. The article may contain at least one additive, such as a fragrance.

In exemplary embodiments, the article may contain at least one plasticizer. The plasticizer may be selected from those that migrate very little, such as citric acid esters or dioctyl adipate.

In exemplary embodiments, a formulation of the layer containing the magnetic particles may be similar to a formulation of a conventional nail varnish, and may contain other plasticizers such as phthalates, for example.

As mentioned above, exemplary embodiments of the article may include an adhesive face. Such an adhesive face may be obtained by the including at least one layer of at least one adhesive material, for example, selected from adhesive materials that are physiologically acceptable for skin or nails. The adhesive material may be a single-layer or multi-layer material.

In exemplary embodiments, the adhesive material may comprise a polymer or a polymeric system that may comprise one or more different kinds of polymer. The adhesive material may be in the form of a polymer solution or a dispersion of polymer particles in a solvent. The adhesive material may further contain a plasticizer, where appropriate or desired.

In exemplary embodiments, the adhesive materials may comprise adhesive polymers selected from: polyurethanes; acrylic polymers; silicones; butylic gums, such as particular polyisobutylenes; ethylene and vinyl acetate polymers; polyamides that are optionally modified by fatty chains; natural gums; and mixtures thereof.

In exemplary embodiments, the adhesive material may be in the form of a layer including a thickness lying in a range of about 1 μm to about 100 μm, a range of about 1 μm to about 50 μm, or a range of about 1 μm to about 25 μm.

In exemplary embodiments, the layer formed by the adhesive material may be directly in contact with the material containing the magnetic particles.

Advantageously, the adhesive material and the material containing the magnetic particles may be compatible as a result of their chemical natures.

Where appropriate or desired, the adhesive material may also contain magnetic particles, so as to contribute to an optical effect when the other layers are not completely opaque.

Exemplary embodiments of the present invention may provide a method of manufacturing an article configured to be secured to skin, hair, nails, or false nails, the method comprising: away from a surface on which the article is to be applied, forming at least one layer of a material containing magnetic particles that are movable under an effect of a magnetic field; and before drying or cooling the layer, exposing the magnetic particles to a magnetic field to orientate and/or displace at least a fraction of the magnetic particles to form a pattern.

In exemplary embodiments, the material containing the magnetic particles may be a film-forming material.

During manufacture of the article, the magnetic field may be exerted by at least one permanent magnet or by at least one electromagnet.

In exemplary embodiments, the magnetic field may be applied at least when the magnetic particles are movable in the material in which they are contained, so as to form one or more patterns. To do this, the layer of material containing the magnetic particles may advantageously be at least partially fluid when the magnetic field is applied, which takes place before use, during manufacture of the article.

Exemplary embodiments of the present invention may provide a kit comprising at least one article, as defined above, and packaging for the article(s).

Exemplary embodiments of the present invention may provide a method of applying makeup, in which an article, as defined above, is secured to skin, hair, nails, or false nails.

### BRIEF DESCRIPTION OF THE DRAWINGS

Various details of the present invention may will be better understood on reading the following detailed description of non-limiting embodiments, and on examining the accompanying drawings, which form an integral part of the description, and in which:

FIG. 1 is a diagrammatic view illustrating an exemplary an article;

FIG. 2 is a diagrammatic axial cross-sectional view of the article of FIG. 1;

FIG. 3 is a diagrammatic view illustrating the article in use;

FIG. 4 is a diagrammatic view illustrating a plurality of exemplary articles;

FIG. 5 is a diagrammatic axial cross-sectional view of another exemplary article;

FIG. 6 is a diagrammatic view illustrating an exemplary article in packaging;

FIGS. 7 and 8 are diagrammatic view illustrating two other exemplary articles; and

FIG. 9 is a view similar to FIG. 2 of another exemplary article.

### DETAILED DESCRIPTION OF EMBODIMENTS

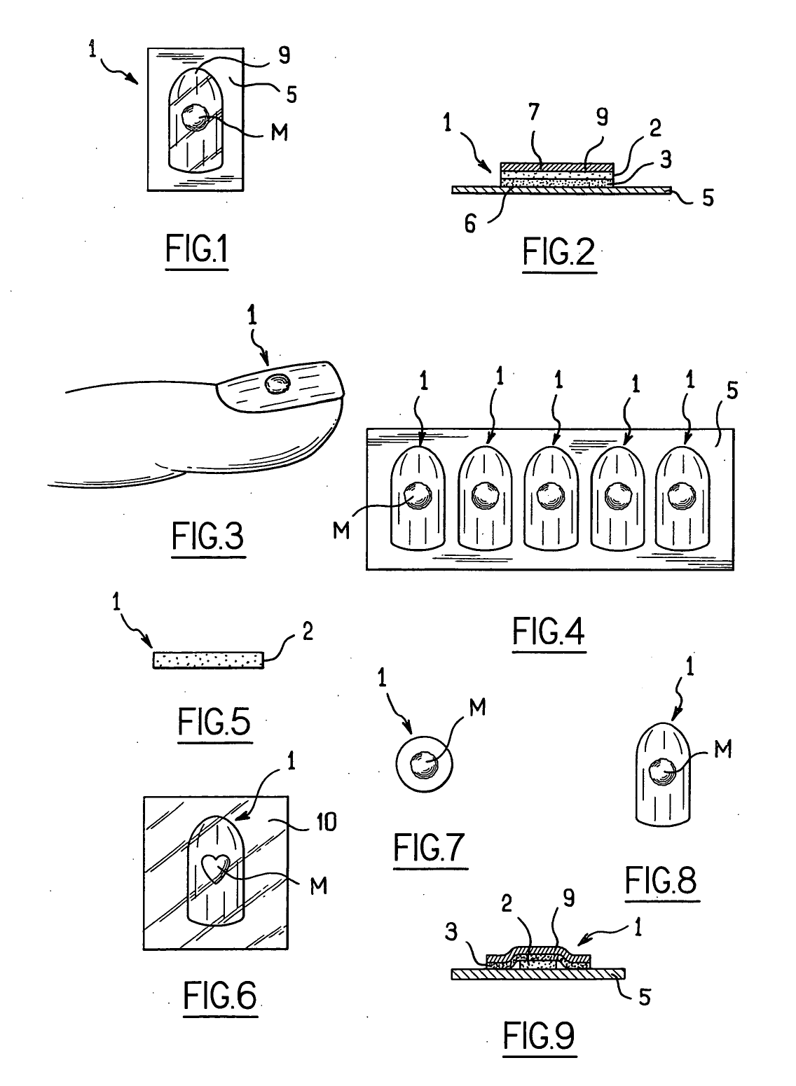

FIGS. 1 and 2 show an exemplary article 1 comprising a film 2 containing magnetic particles, and a layer of an adhesive material 3 including a bottom face that constitutes an adhesive face 6 of the article 1. Before use, a removable protective membrane 5 may protect the adhesive face 6.

A protective film 9, that may be transparent in the exemplary embodiment illustrated, may cover the film 2 so as to protect the film 2.

In the exemplary embodiment illustrated, the article 1 may be flexible and may be configured to be secured to a natural or synthetic nail.

U.S. Pat. No. 5,415,903, the entire disclosure of which is incorporated herein by reference, describes a method that may be used, at least in part, to make the article.

A varnish containing at least one plasticizer and one film-forming polymer may be dissolved in an organic solvent with magnetic pigments and any other coloring substances or fillers, and may then be applied to the protective film 9. The varnish may be dried, for example, by recuperating the solvent. The protective film 9 that is coated with the film 2 may be laminated, on the side of the varnish, with the adhesive film 3 and a removable membrane 5.

The particles may be oriented before the solvent has completely evaporated. In the exemplary embodiment illustrated, the magnetic particles may be oriented under an effect of a magnetic field to form a visible pattern M, which, in the exemplary embodiment illustrated, is in a shape of a sphere.

During use, the protective membrane 5 may be removed, and the article 1 may be applied to a synthetic or natural nail, as illustrated in FIG. 3.

Once secured to the nail, the article 1 may be cut or filed, for example, to follow contours of the nail.

The protective membrane 5 may be common to a plurality of articles 1, as illustrated in FIG. 4. The number of articles that are grouped together on a common protective membrane 5 may vary, and may be equal to five, for example, as in the exemplary embodiment illustrated. In a variant not shown, the articles may include sizes and/or shapes that are different, so as to match shapes of various fingernails.

The article 1 may include a different structure without going beyond the ambit of the present invention.

In an exemplary embodiment illustrated in FIG. 5, the article 1 may not include any adhesive material. In this case, for example, the article comprising the film 2 may be secured by a layer of glue that is deposited by the user, at the moment of use, on a support to be covered by the article and/or on the article.

The article 1 thus may have no need for a removable protective membrane 5, as also illustrated in FIG. 5, or even for a protective film 9.

For example, the article 1 may also be made by molding a thermoplastic material containing magnetic pigments, and the magnetic pigments may be oriented before the thermoplastic material is cooled, when the thermoplastic material is still fluid.

FIG. 6 illustrates a kit comprising an article 1 disposed in a packaging 10 that is closed in a sealed manner.

Such packaging may be useful in preventing the article from degrading during storage.

When the film 2 includes adhesive properties, the layer 3 of adhesive material in the exemplary embodiment illustrated in FIG. 2 may be eliminated, where appropriate or desired.

FIG. 7 illustrates another exemplary article 1 constituting a patch, preferably flexible, for securing to skin.

The exemplary article 1 illustrated in FIG. 8 constitutes a substantially rigid false nail that may not include adhesive material, and may be glued onto a natural nail.

In the exemplary embodiment illustrated in FIG. 9, the film 2 containing the magnetic particles may be covered by a protective film 9 that is coated on one face with an adhesive layer 3.

The film 9 may extend around the film 2 in such a manner as to secure the film 2 to skin, a nail, or a false nail.

Before use, the adhesive layer 3 may be protected by a non-stick, removable protective membrane 5.

Naturally, the invention is not limited to the embodiments described above.

For example, the article may include a plurality of optionally different patterns.

The expression “comprising a” should be understood as being synonymous with “comprising at least one”, unless specified to the contrary.

Although the present invention herein has been described with reference to particular embodiments, it is to be understood that these embodiments are merely illustrative of the principles and applications of the present invention. It is therefore to be understood that numerous modifications may be made to the-illustrative embodiments and that other arrangements may be devised without departing from the spirit and scope of the present invention.

What is claimed is:

1. An article configured to be secured to keratinous materials, the article containing magnetic particles that are oriented in at least one pattern.

2. An article according to claim 1, further comprising an adhesive face.

3. An article according to claim 1, further comprising a film containing said magnetic particles.

4. An article according to claim 3, wherein the film comprises a film-forming material with at least one solvent removed by drying.

5. An article according to claim 1, wherein the magnetic particles comprise a magnetic material selected from the group consisting of: iron, nickel, cobalt, an iron alloy, a nickel alloy, a cobalt alloy, an iron oxide, a nickel oxide and a cobalt oxide.

6. An article according to claim 5, wherein the magnetic material comprises Fe₃O₄.

7. An article according to claim 1, wherein the magnetic particles are aspherical.

8. An article according to claim 1, further comprising at least one coloring substance.

9. An article according to claim 2, wherein the adhesive face is defined by at least one layer of at least one adhesive material.

10. An article according to claim 9, wherein the adhesive material is configured such that the article is repositionable.

11. An article according to claim 2, further comprising a removable protective membrane that covers the adhesive face before use.

12. An article according to claim 1, wherein the article is flexible.

13. An article according to claim 1, wherein the article is substantially rigid.

14. An article according to claim 1, wherein the article comprises a false nail that is configured to cover at least part of a natural nail.

15. An article according to claim 1, wherein the article comprises a patch.

16. An article according to claim 1, wherein the keratinous materials comprise at least one of skin and nails.

17. A method of manufacturing an article configured to be secured to keratinous materials, said method comprising:
away from a surface on which the article is to be applied, forming at least one layer of a material containing magnetic particles that are movable under an effect of a magnetic field; and
before at least one of drying and cooling the layer, exposing the magnetic particles to a magnetic field to at least one of orientate and displace at least a fraction of said magnetic particles to form a pattern.

18. A method according to claim 17, wherein said material comprises a film-forming material.

19. A method according to claim 17, wherein the article is configured to be secured to at least one of skin and nails.

20. A kit comprising:
at least one article as defined in claim 1; and
a packaging for the at least one article.

21. A method of applying makeup, comprising:
providing an article as defined in claim 1; and
securing the article to keratinous materials.

22. A method according to claim 21, wherein the article is secured to at least one of skin and nails.
